(19) United States
(12) Patent Application Publication
(10) Pub. No.: US 2017/0099022 A1
(43) Pub. Date: Apr. 6, 2017

(54) APPARATUS HAVING AT LEAST ONE AC MOTOR

(71) Applicant: Texmag GmbH Vertriebsgesellschaft, Thalwil (CH)

(72) Inventors: FLORIAN HURKA, Gessertshausen (DE); JUERGEN EISEN, Augsburg (DE)

(21) Appl. No.: 15/279,593

(22) Filed: Sep. 29, 2016

(30) Foreign Application Priority Data
Oct. 2, 2015 (DE) 10 2015 012 688.1

(51) Int. Cl. H02P 9/14; H02P 23/00; H02P 29/032; H02P 27/08

(52) U.S. Cl. CPC H02P 9/14; H02P 27/08; H02P 23/0004; H02P 29/032

(57) ABSTRACT

An apparatus (1) consists of an AC motor (2), a controller (5) and a power driver (6). In this case, the controller (5) and the power driver (6) are supplied with electric power firstly by an operating voltage (9) and secondly by a generator voltage (10) from the AC motor (2). When the operating voltage (9) is absent but the generator voltage (10) is present, the magnetization of the AC motor (2) is influenced such that the generator voltage (10) is kept between two limit values in order firstly to generate sufficient power for the operation of the controller (5) and of the power driver (6) and secondly to observe permitted voltage limits for the power driver (6).

The present application claims priority to German Patent Application no:

DE 10 2015 012 688.1, filed Oct. 2, 2015.

### FIELD OF THE INVENTION

The invention relates to an apparatus having at least one AC motor, at least one actuating unit and at least one object driven by the AC motor.

### DESCRIPTION OF THE PRIOR ART

DE 195 09 974 C2 discloses an apparatus of the type in question. It has an AC motor that is actuated by an actuating unit, namely an inverter supplied with an operating voltage. This actuating unit has electronic switching elements normally in the form of transistors, which have only a limited dielectric strength. This AC motor drives an arbitrary object. In this situation, it may occur that the AC motor generates a decelerating torque counter to the direction of rotation. Therefore, what is known as generator mode is referred to in this case. In this situation, the AC motor slows down the object, and in so doing generates electric power at the same time. This electric power can lead to relatively high voltages that overload the actuating unit and can result in voltage breakdown. To avoid this, the magnetization of the AC motor is increased in generator mode, as a result of which the magnetic losses are increased accordingly and the electric power generated is converted into heat. This provides good protection for the actuating unit against overvoltage from the AC motor in generator mode. This known apparatus has proved itself repeatedly in practice and forms the starting point for the present invention.

The invention is based on the object of providing an apparatus of the type cited at the outset that improves the protection for the actuating unit for the AC motor.

The invention achieves this object by means of the following features.

### BRIEF SUMMARY OF THE INVENTION

The apparatus according to the invention has at least one AC motor, at least one actuating unit and at least one object that is driven by the at least one AC motor. In this case, it is irrelevant whether this driving takes place directly or indirectly, for example via one or more gear mechanisms. It is furthermore irrelevant how this object is driven. By way of example, the object could be driven to be rotated, shifted or moved along an arbitrary curve. This list is not intended to be understood to be conclusive, however. When the object is driven, however, it may also occur that the object has its movement slowed down. In this case, the torque of the at least one AC motor has a slowing-down effect counter to the direction of rotation, so that the at least one AC motor converts mechanical energy into electric power in generator mode. In order to protect the at least one actuating unit against excessive voltage spikes in the generator voltage from the at least one AC motor, the magnetization of the at least one AC motor is altered, so that the electric power generated in generator mode is converted into heat. As a result, the at least one AC motor is reliably protected against overvoltage spikes in generator mode in the course of operation. However, it may occur that the at least one AC motor enters generator mode even when the operating voltage is switched off, for example when the at least one object is moved by external circumstances. External circumstances of this kind may be due to inertial forces being exceeded, for example, when the whole apparatus is speeded up, for example during transportation or assembly. Alternatively, it is also conceivable for the at least one object to be speeded up by gravity, spring force or compressive force from a fluid. This list is not intended to be understood as conclusive. In all of these cases, the moving object means that the at least one AC motor is supplied with mechanical energy that said AC motor converts into electric power in generator mode. Without a supply voltage applied, however, the actuating unit is unable to react to this dangerous operating state. The invention therefore proposes that the apparatus has at least one controller that is supplied with electric power by the at least one AC motor when the supply voltage is switched off. This means that the electric power generated by the at least one AC motor in generator mode is used to operate the at least one controller, even when there is no kind of supply voltage applied. However, it has been found that this measure, taken on its own, is not sufficient to protect the actuating unit for the at least one AC motor against overvoltage. The following problem arises in this case: if the at least one object is a lifted load, for example, which is coupled to the at least one AC motor by means of a non-self-locking gear mechanism, for example, then this load drives the at least one AC motor by supplying kinetic energy, and the at least one controller then counteracts power generation by increasing the magnetization of the at least one AC motor and generates heat energy. This would slow down the load to a standstill, as a result of which the at least one controller would be stripped of the electric power, which then could no longer affect the at least one AC motor. However, this results in a loss of braking action and hence again in acceleration of the load, so that the at least one object is very severely slowed down and speeded up again in fits and starts in this case. This intermittent slowing down is worthwhile neither for the mechanics nor for the at least one AC motor, since it can lead to considerable wear. Furthermore, there is then entirely the risk of voltage spikes being generated in generator mode that are above the permitted voltage values for the at least one actuating unit. In order to solve these problems, it is proposed that the at least one controller influences the magnetization of the at least one AC motor such that the generator voltage therefrom lies between two prescribed limit values. These two limit values may even be the same, so that the controller regulates the generator voltage to the common limit value in this case. This is not absolutely necessary, however. The controller accordingly does not even attempt to bring the speed of the at least one AC motor to zero, but rather limits the speed within a prescribed window. This means that the at least one object is not slowed down to the speed of zero, but the whole arrangement ensures that the generator voltage that is generated by the at least one AC motor is limited to permitted values. Furthermore, the generator voltage is also limited in a downward direction, so that the at least one controller is provided with electric power for a sufficient time in order to influence the magnetization of the at least one AC motor. This state is then maintained until the at least one object reaches a mechanical stop or the externally supplied kinetic energy is exhausted. This means that this apparatus can protect the at least one AC motor even in operating states in which no operating voltage is applied, as a result of which the protection of the at least one actuating unit for the at least one AC motor is improved accordingly.

In order to ensure that the at least one controller can perform its protective function, it is advantageous if the lower limit value is chosen such that the at least one AC motor generates sufficient electric power for the operation of the at least one controller and of the at least one actuating unit. Hence, the at least one controller can execute its program in order to protect the at least one actuating unit against overvoltage. What is important in this case is that the electric power generated is also sufficient to supply power to the at least one actuating unit so that the at least one controller can also actively affect the at least one AC motor. When the generator voltage drops below the lower limit value, although it is no longer possible for the at least one controller to use the at least one actuating unit, measurement and monitoring functions continue to be possible for a certain time, which means that when the speed of the at least one AC motor and hence the generator voltage generated rise, the at least one controller can immediately take action again by increasing the magnetization.

The upper limit value is preferably chosen such that the generator voltage generated by the at least one AC motor is below the permitted voltage for the at least one actuating unit. Hence, the at least one actuating unit is reliably protected against overvoltage. Between the lower and upper limit values, a permitted range of the generator voltage that can be covered by the at least one controller is obtained. On the basis of this permitted range, the at least one controller may be in the form of a two-point regulator, so that an extremely simple but fast-acting control algorithm is obtained. Since the apparatus according to the invention has exclusively a protective function, the control outcome attained plays only a very minor part. By contrast, it is much more important that when the generator voltage appears, the at least one controller can take action very quickly before the generator voltage generated exceeds the permitted limit value. Hence, with this type of control, speed precedes accuracy. Alternatively, however, voltage regulation to a setpoint value, for example in the form of a P, PI, PD or PID regulator, is also possible.

Since the generator voltage generated by the at least one AC motor goes begging in the at least one actuating unit, it rises relatively quickly, which means that the at least one controller needs to react correctly in a very short time in order to effectively protect the at least one actuating unit. This means that it is not possible to perform a detailed analysis of the type of mechanical energy supply, however, since such an analysis requires too long a time. On the other hand, however, it is also important to react in pinpoint fashion. In the case of a large supply of mechanical energy, the magnetization of the at least one AC motor needs to be increased very severely, while in the case of a small supply of energy, the magnetization should by contrast be kept down so as not to prematurely wipe out the generator voltage generated. For this purpose, it is advantageous if the magnetization of the at least one AC motor increases as the generator voltage increases. In this way, although a distinction is not drawn between the operating situations of fast movement of the object with a small force, on the one hand, and slow movement of the object with a large force, on the other hand, the magnetization is set to a sensible initial value by this measure, so that the braking action of the at least one object is sufficient to protect the at least one actuating unit, but abrupt slowing down of the at least one object to the speed of zero is prevented. On the basis of this starting point, the at least one controller can then use control to return the at least one AC motor to a safe mode, for example in order to produce a ramp-like braking action.

A continuous function has proved successful for the dependency of the magnetization on the generator voltage. In this context, however, the term “continuous” is also intended to be understood to mean a digital approximation to a continuous function.

In particular, a linear function has proved successful for the dependency of the magnetization on the generator voltage. It is therefore merely necessary for the generator voltage to be measured, for example, using a digital-to-analogue converter, with multiplication by a constant directly determining the magnetization that needs to be set in the at least one AC motor. This computation can be effected relatively quickly, which means that reliable protection is obtained.

In order to identify whether there is a normal operating state with a standard actuation of the at least one AC motor or an emergency state in the generator mode with no operating voltage, the at least one controller has checking means that are used to ascertain the supply voltages of the operating voltage and the generator voltage. In this case, power is supplied to the at least one controller by both voltage sources, which are preferably decoupled from one another. If the checking means reveal that the operating voltage is close to zero, then the at least one controller switches to emergency mode when a generator voltage is present, in order to protect the actuating unit for the at least one AC motor. When an operating voltage is present, the at least one controller switches to normal mode, in order to operate the at least one AC motor. In this normal mode, the at least one AC motor can be used for driving and, in generator mode, it can be used for braking, and when the at least one object is braked, it can also be brought to a standstill independently of a mechanical stop, in contrast to emergency mode.

Since the operating voltage needs to be checked quickly, at least one comparator has proved successful for the checking means, said comparator being connected firstly to the operating voltage and secondly to a reference voltage source. In this case, the operating voltage is supplied to the at least one comparator preferably by a voltage divider or a voltage protection apparatus, such as a Zener diode, for example. Depending on the permitted voltage input range of the at least one controller, it is also possible to dispense with such apparatuses, however. The at least one comparator can compare the operating voltage with the reference voltage in order to decide in a very short time whether sufficient operating voltage is applied for normal mode or whether a switch to emergency mode is necessary.

In order to keep the generator voltage generated by the at least one AC motor safely within the permitted range, the at least one controller has at least one regulator that regulates the generator voltage. This at least one regulator may be in the form of a simple two-point regulator. Alternatively, however, the at least one regulator may also be in the form of a proportional regulator, for example. In this case, the at least one regulator can affect the magnetization of the at least one AC motor in a sensitive manner, in order to keep the generator voltage generated by the latter constantly at a prescribed value.

A P response has proved successful for the at least one regulator. This means that the output signal from the regulator is proportional to the ascertained actual/setpoint value difference. In this way, it is possible for a very fast control reaction to be produced. The disadvantage of this control response is fundamentally that exact regulation to the setpoint value is not possible. Rather, in the corrected state, an actual/setpoint value discrepancy remains that is indirectly proportional to the proportional value P of the regulator. This proportional value P furthermore cannot be chosen to be of arbitrary magnitude, since otherwise the whole regulator generates an undamped oscillation. The cited discrepancy can normally be tolerated, however, if the voltage difference between the minimum operating voltage of the controller and the maximum permitted voltage of the actuating unit is sufficiently large. Alternatively, the at least one regulator may have a PI response. This means that the at least one regulator reacts both proportionally to the control error occurring and proportionally to the time integral thereof, with both reactions being added. The proportional control component delivers a fast control reaction, which is important for protecting the at least one actuating unit. By contrast, the integral component prompts the control difference that is present on the at least one regulator to be able to be corrected to zero over a certain time. As a further alternative, a PD or PID response is conceivable. This differs from the P or PI response described above in that additionally, a control reaction that is proportional to the time derivative of the control error is generated that is added to the P or PI response. The essential effect of the D response is that it shifts the phase of the regulator, so that the oscillation condition of the regulator is satisfied only at higher P values. This means that the additional D component of the control response can increase the P component without generating an undamped oscillation in the regulator. This particularly speeds up the control reaction, which means that the regulator brings the applied generator voltage to the desired value more quickly. This improves protection considerably.

### BRIEF DESCRIPTION OF DRAWINGS

Other advantages and characteristics of this invention will be explained in the detailed description below with reference to the associated figures that contain several embodiments of this invention. It should however be understood, that the figure is just used to illustrate the invention and does not limit the scope of protection of the invention.

FIG. 1 shows a block diagram of an apparatus having an AC motor and

FIG. 2 shows a detail circuit diagram of the controller shown in FIG. 1.

### DETAILED DESCRIPTION OF THE INVENTION

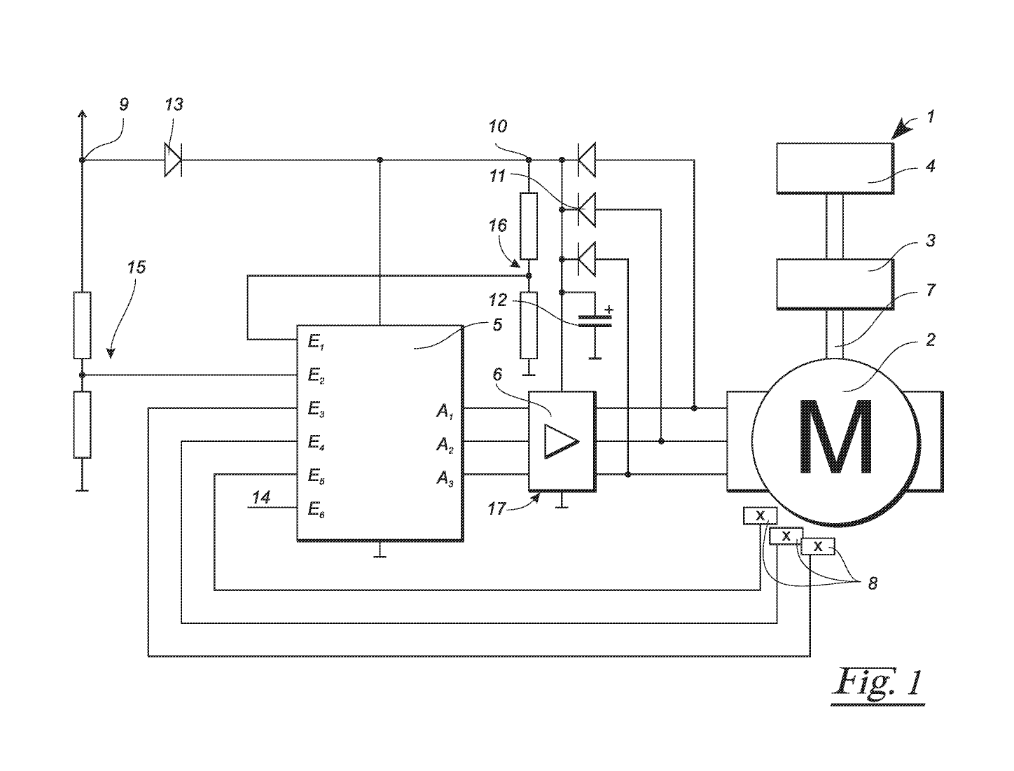

FIG. 1 shows an apparatus 1 having an AC motor 2. The AC motor 2 drives an object 4 by means of a gear mechanism 3. In this situation, the AC motor 2 can both speed up and slow down the object 4. To this end, the AC motor 2 is connected to a controller 5 that actuates a power driver 6, preferably with MOS field-effect transistors contained therein, via outputs A₁, A₂, A₃. This power driver 6 forms an actuating unit 17 for the AC motor 2 and is connected to exciter coils, not shown, of the AC motor 2, which form a stator. These exciter coils generate a rotating field in which a rotor, preferably with permanent magnets, rotates. In this case, the magnetic interaction between the stator and the rotor exerts a torque on a driveshaft 7 that leads to the gear mechanism 3.

In order to be able to determine firstly the speed and secondly the present rotor position of the AC motor 2, the latter has sensors 8, which are shown merely by way of example as Hall sensors. These detect the magnetic field from the rotor in different angular positions, so that the rotor position and the speed of the rotor can be computed therefrom. The sensors 8 are connected to the controller 5 via inputs E₃, E₄ and E₅.

The controller 5 and the power driver 6 are supplied with electric power jointly by an operating voltage 9, said electric power delivering a constant voltage and the current required for operation. If the AC motor 2 aims to speed up or slow down the object 4, then the controller 5 generates pulse-width-modulated signals at its outputs A₁, A₂ and A₃ in order to actuate the stator of the AC motor 2 as appropriate.

It may now occur that the object 4 is moved, the operating voltage 9 being switched off. By way of example, the object 4 may be suspended and break away by virtue of external manipulations. In this way, the object 4 speeds up the rotor of the AC motor 2 via the non-self-locking gear mechanism 3. This puts the AC motor 2 into generator mode, in which it converts the mechanical energy introduced into electric power. Since the power driver 6 is designed such that it can only route power to the AC motor 2, the problem arises in this operating state that the power generated by the AC motor 2 cannot be dissipated. Hence, the generator voltage 10 generated by the AC motor 2, which is also called the intermediate circuit voltage, rises quickly and can assume extremely high values without further measures. These high voltage values result in the power driver 6 being destroyed, however.

In order to avoid this circumstance, the controller 5 and the power driver 6 are additionally supplied with electric power by the generator voltage 10. For this purpose, the AC voltage generated by the AC motor 2 is rectified by means of a rectifier 11 and smoothed by means of a capacitor 12. So that the generator voltage 10 does not perturb the operating voltage 9 that may be applied, the two are decoupled by a diode 13, which is shown merely by way of example. In this way, the controller 5 and the power driver 6 are supplied with power even when the operating voltage 9 is switched off if there is a sufficiently high generator voltage 10.

So that the controller 5 can distinguish whether the AC motor 2 needs to be actuated in the usual way or—with the operating voltage 9 switched off—an appropriate emergency program needs to be executed, the operating voltage 9 is supplied to the controller 5 via a voltage divider 15 at a further input E₂. By measuring the voltage on the input E₂, for example using an analogue-to-digital converter, the controller 5 is therefore able to identify whether the operating voltage 9 is in the setpoint range and therefore a normal operating program can be executed to actuate the AC motor 2. In the absence of the operating voltage 9, on the other hand, an emergency program is executed when a generator voltage is present. For this emergency program, the controller 5 also needs the information about the applied generator voltage 10, which, for this purpose, is supplied to the controller 5 via a further voltage divider 16 at an input E₁, downstream of which an analogue-to-digital converter is situated.

For operation, the controller 5 also requires a piece of information concerning the speed to be applied for the AC motor 2. An appropriately coded numerical value for the speed 14 is supplied to the controller 5 via an input E₆, and there is no stipulation as to whether the input E₆ comprises one or more lines. If the input E₆ has only one line, then the speed 14 is transmitted to the controller serially. If there are multiple lines available for this, then it is also possible to use parallel or part-serial/part-parallel transmission.

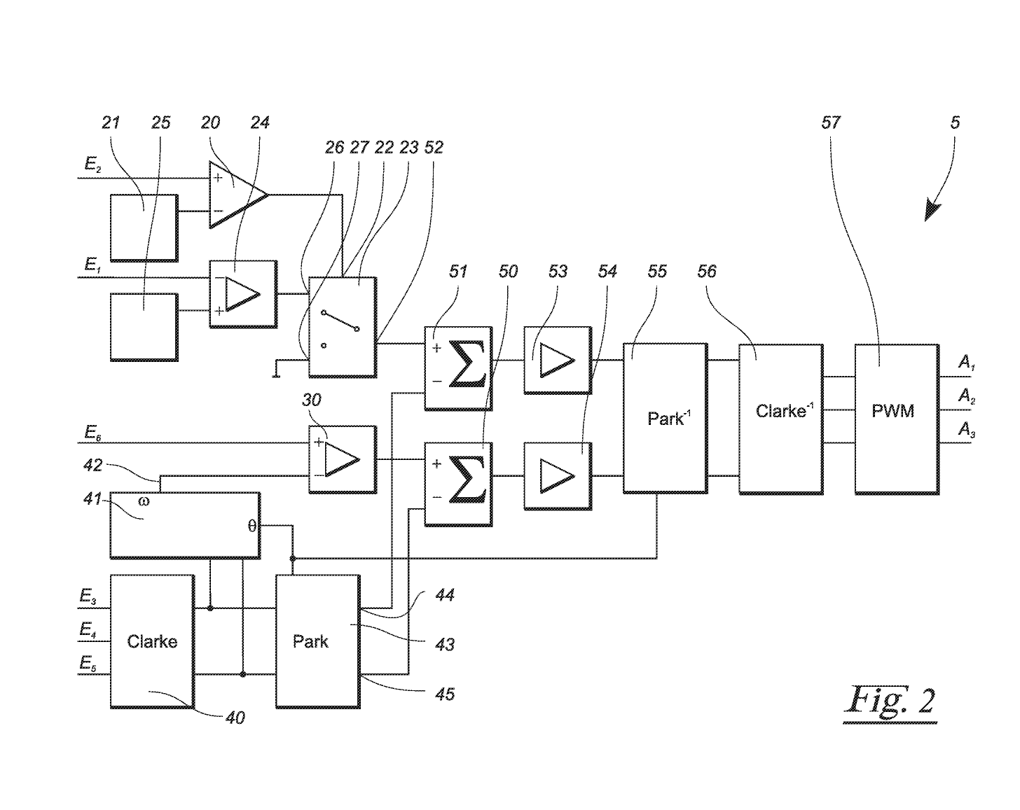

The operation of the controller 5 is explained on the basis of the detail circuit diagram shown in FIG. 2, where identical reference symbols denote identical parts. The controller 5 has the aforementioned inputs E₁ to E₆ and the likewise mentioned outputs A₁ to A₃. The power supply for the controller 5 is not shown in FIG. 2 for the sake of simplicity.

The input E₂, which is connected to the operating voltage 9 via the voltage divider 15, is routed to a comparator 20 that compares the voltage applied to the input E₂ with an internal reference voltage source 21. If the voltage applied to the input E₂ is above the output voltage from the reference voltage source 21, then the comparator 20 delivers a logic 1 signal at its output, otherwise a 0 signal. The output of the comparator 20 is connected to a control input 22 of a changeover switch 23.

The input E₁, which is connected to the generator voltage 10 via the voltage divider 16, is routed to an actual value input on a regulator 24, which preferably has a P, PI, PD or PID response. A setpoint value input of the regulator 24 is connected to a setpoint value generator 25 that delivers a variably prescribable setpoint value voltage. The output voltage from the setpoint value generator 25 defines the setpoint value of the generator voltage 10 that is adjusted by the controller 5. The regulator 24 is connected to a signal input 26 of the changeover switch 23, which is active if the operating voltage 9 is too low or absent, in order to influence the magnetization of the AC motor 2 in linear dependence on the generator voltage 10 generated. The changeover switch 23 is connected to earth, that is to say OV, via a signal path 27, in order to generate a zero signal at an output 52 of the changeover switch 25 during normal operation with operating voltage 9 applied. Alternatively, the signal path 27 could also be connected to a braking identification circuit that increases the magnetization of the AC motor 2 in the case of negative torque.

Via the inputs E₃, E₄ and E₅, the controller 5 receives the information from the sensors 8 that reflects the respective present magnetic field values for the rotor of the AC motor 2. The signals on the inputs E₃ to E₅ are subjected to a Clarke transformation. This has the following mathematical definition:

$$( \begin{matrix}{I}_{α} \\ {I}_{β}\end{matrix} ) = \frac{2}{3} ( \begin{matrix}1 & - \frac{1}{2} & - \frac{1}{2} \\ 0 & \frac{\sqrt{3}}{2} & - \frac{\sqrt{3}}{2}\end{matrix} ) ( \begin{matrix}{I}_{U} \\ {I}_{V} \\ {I}_{W}\end{matrix} )$$

This transformation converts the three-dimensional vector at the inputs E₃ to E₅ into a two-dimensional vector without losing information in the process. The reason is that the sum of all magnetic field values at the sensors is always zero. Hence, a two-dimensional piece of information about the magnetic field values, namely in the magnetic field direction of the rotor and at the angle of 90° divided by the number of poles of the rotor, is sufficient. This is performed by the Clarke transformation.

At the output, the Clarke transformation 40 is connected to a computation circuit 41 that takes these values and determines the present angle of rotation θ and the present speed ω of the rotor on the basis of time. The present speed ω ascertained in this process is connected via a signal path 42 to the regulator 30, which thus performs an actual/setpoint value comparison. The results of the Clarke transformation 40 are furthermore subjected to a Park transformation 43. This Park transformation 43 transforms the signals from the Clarke transformation 40 into the rotating system of the rotor, so that there are no further frequency-dependent signals. The result of the Park transformation is a vector that is essentially constant over one revolution of the rotor of the AC motor 2. The Park transformation is defined in the following manner:

$$( \begin{matrix}{I}_{d} \\ {I}_{q}\end{matrix} ) = ( \begin{matrix}cos ( θ ) & sin ( θ ) \\ - sin ( θ ) & cos ( θ )\end{matrix} ) ( \begin{matrix}{I}_{α} \\ {I}_{β}\end{matrix} )$$

This is an ordinary rotation matrix, the angle θ being the present angle of rotation of the rotor. This is obtained from the computation circuit 41 and supplied to the Park transformation 43. The result of the Park transformation 43 is a two-dimensional vector that outputs the stator field in the direction of the magnetic field axis of the rotor at an output 44 and outputs said stator field at an angle of 90° divided by the number of poles of the rotor relative to the field direction of the rotor at an output 45.

In this case, it should be borne in mind that the stator field at the output 45 exerts a maximum torque on the rotor, while the stator field in the field direction of the rotor delivers only reactive power, which is converted into heat in the AC motor 2. For this reason, the controller 5 will, with operating voltage 9 applied, actuate the outputs 44, 45 such that when the AC motor 2 is being driven, that is to say when there is a torque in the direction of rotation, only the output 45 will be active. When the AC motor 2 is slowed down, that is to say when a torque counter to the direction of rotation of the rotor is generated, the output 44 will, by contrast, be active in order to convert the electric power generated by the AC motor 2 into heat effectively within said AC motor.

Under normal operating conditions, that is to say with operating voltage 9 applied, the input E6 delivers the setpoint value for the speed 14 of the AC motor 2. Said AC motor is connected to a further regulator 30 having a P, PI, PD or PID response for regulating the speed of the AC motor 2. For this purpose, the output of the regulator 30 is connected to a non-inverting input of the summator 50. The summator 50 is furthermore connected to the output 45 of the Park transformation 43 in an inverting manner. A further summator 51 is connected to an output 52 of the changeover switch 23 in a non-inverting manner. It is furthermore connected to the output 44 of the Park transformation 43 in an inverting manner. These summators 50, 51 prompt an actual/setpoint value comparison between the actual values of the outputs 44, 45 and the relevant setpoint values. The outputs of said summators are connected to regulators 53, 54 that are implemented as P, PI, PD or PID regulators. Output signals from these regulators 53, 54 are connected to an inverse Park transformation 55. The inverse Park transformation 55 essentially corresponds to the Park transformation 43 with the opposite direction of rotation. It is defined in the following manner:

$$( \begin{matrix}{I}_{α} \\ {I}_{β}\end{matrix} ) = ( \begin{matrix}cos ( θ ) & - sin ( θ ) \\ sin ( θ ) & cos ( θ )\end{matrix} ) ( \begin{matrix}{I}_{d} \\ {I}_{q}\end{matrix} )$$

In this case, the present angle of rotation θ is again needed, which the computation circuit 41 supplies to the inverse Park transformation 55. The inverse Park transformation 55 is connected to an inverse Clarke transformation 56, which is defined in the following manner:

$$( \begin{matrix}{I}_{U} \\ {I}_{V} \\ {I}_{W}\end{matrix} ) = \frac{2}{3} ( \begin{matrix}1 & 0 \\ - \frac{1}{2} & \frac{\sqrt{3}}{2} \\ - \frac{1}{2} & - \frac{\sqrt{3}}{2}\end{matrix} ) ( \begin{matrix}{I}_{α} \\ {I}_{β}\end{matrix} )$$

This takes the two-dimensional vector of the inverse Park transformation 55 and again generates a three-dimensional vector for actuating the stator coils of the AC motor 2.

The output of the inverse Clarke transformation 56 is connected to a pulse width modulator 57 that converts the relevant current values for the stator coils of the AC motor 2 into a pulsed signal having a varying pulse width. This pulse-width-modulated signal is made available directly at the outputs A₁ to A₃ in order to actuate the power driver 6. The pulse width modulation has the advantage that only one signal line per stator coil is needed. Furthermore, extremely simple actuation for the power driver 6 is obtained, since, in contrast to analogue voltages, only digital voltages need to be generated. This means that a simple switching transistor that can switch the current on and off is sufficient for the power driver 6.

Since some of the embodiments of this invention are not shown or described, it should be understood that a great number of changes and modifications of these embodiments is conceivable without departing from the rationale and scope of protection of the invention as defined by the claims.

List of reference symbols

| | | | |
|---|---|---|---|
| 1 | Apparatus | 43 | Park transformation |
| 2 | AC motor | 44 | Output |
| 3 | Gear mechanism | 45 | Output |
| 4 | Object | 50 | Summator |
| 5 | Controller | 51 | Summator |
| 6 | Power driver | 52 | Output |
| 7 | Driveshaft | 53 | Regulator |
| 8 | Sensor | 54 | Regulator |
| 9 | Operating voltage | 55 | inverse Park |
| 10 | Generator voltage | | transformation |
| 11 | Rectifier | 56 | inverse Clarke |
| 12 | Capacitor | | transformation |
| 13 | Diode | 57 | Pulse width |
| 14 | Speed | | modulation |
| 15 | Voltage divider | θ | Present angle of |
| 16 | Voltage divider | | rotation |
| 17 | Actuating unit | ω | Present speed |
| 20 | Comparator | | |
| 21 | Reference voltage | | |
| | source | | |
| 22 | Control input | | |
| 23 | Converter | | |
| 24 | Regulator | | |
| 25 | Setpoint value | | |
| | generator | | |
| 26 | Signal path | | |
| 27 | Signal path | | |
| 30 | Regulator | | |
| 40 | Clarke transformation | | |
| 41 | Computation circuit | | |
| 42 | Signal path | | |

1. An apparatus having at least one AC motor, at least one actuating unit driving said at least one AC motor, at least one controller and at least one object being moveable and coupled to said AC motor, said at least on AC motor is operable
in at least one motor mode driving said at least one object by converting electric power into mechanical power, and
in at least one generator mode, converting mechanical power from said moving object into electric power and producing a generator voltage,
wherein said at least one AC motor has an alterable magnetization in order to convert said electric power generated in said generator mode into heat,
said at least one controller can be supplied with
an operating voltage, and
in the case, said operating voltage being switched off, with said generator voltage produced in generator mode,
said at least one controller influencing said magnetization of said at least one AC motor such that said generator voltage being between two pre-set limit values.

2. The apparatus according to claim 1, wherein said lower limit value is chosen such that said generator voltage generated by the said at least one AC motor is sufficient for the operation of said at least one controller and of said at least one actuating unit.

3. The apparatus according to claim 1, wherein said at least one actuating unit has a permitted voltage range and said upper limit value is chosen such that said generator voltage generated by said at least one AC motor is below said permitted voltage range.

4. The apparatus according to claim 1, wherein said magnetization of said at least one AC motor increases between said limit values as said generator voltage increases.

5. The apparatus according to claim 1, wherein said magnetization of said at least one AC motor is a continuous function of said generator voltage from said at least one AC motor.

6. The apparatus according to claim 1, wherein said magnetization is a linear function of said generator voltage at least in a subrange between said limit values.

7. The apparatus according to claim 1, wherein said at least one controller is suppliable with electric power by said operating voltage and by said generator voltage, and said at least one controller having checking means for identifying the source of said electric power.

8. The apparatus according to claim 7, wherein the checking means are formed by at least one comparator, being connected firstly to said operating voltage and secondly to a reference voltage source.

9. The apparatus according to claim 1, wherein said at least one controller has at least one regulator that regulates said generator voltage generated by said at least one AC motor.

10. The apparatus according to claim 9, wherein said at least one regulator has a P, PI, PD or PID response.
